(19) United States
(12) Patent Application Publication
(10) Pub. No.: US 2025/0376174 A1
(43) Pub. Date: Dec. 11, 2025

(54) DEVICE AND METHOD FOR CROWD SOURCING DATA AND IMPLEMENTING RECOMMENDATIONS ON A VEHICLE TO INCREASE SAFETY

(71) Applicant: Innova Electronics Corporation, Irvine, CA (US)

(72) Inventors: Truong Nguyen Hai Lam, Binh Duong Province (VN); Thuan Cong Huynh, Irvine, CA (US); Tai Anh Nguyen, Ho Chi Minh City (VN); Quan Hong Nguyen, Ho Chi Minh City (VN)

(21) Appl. No.: 18/734,510

(22) Filed: Jun. 5, 2024

(51) Int. Cl. B60W 50/00; B60Q 1/34; B60Q 5/00; B60W 10/18; B60W 10/22

(52) U.S. Cl. CPC B60W 50/0098; B60Q 1/346; B60Q 5/005; B60W 10/18; B60W 10/22; B60W 2552/35; B60W 2556/50; B60W 2556/65

(57) ABSTRACT

A method for crowdsourcing data related to vehicle capabilities and hazardous roadway conditions device and providing recommended courses of action to a trailing vehicle that increase safety to passengers of the trailing vehicle is disclosed. The method contemplates comparing relative capabilities of leading vehicles and its actions to the capabilities of the trailing vehicle to recommend courses of action that increase safety to the passengers of the trailing vehicle. The capabilities of the leading and trailing vehicle can be determined by looking up the vehicle configurations based on its vehicle identification number in a public or private database.

### BACKGROUND

Vehicle safety is a paramount concern for all drivers and passengers. As such, many efforts have been made to improve vehicle safety, including the development of advanced safety features such as lane departure warning systems, automatic emergency braking, and blind spot monitoring systems. While these features have been successful in improving vehicle safety, there is still room for improvement.

Accordingly, there is a need in the art to improve vehicle safety.

### SUMMARY

A method and a device for crowd sourcing vehicle and hazardous roadway condition data and implementing recommended courses of action in a trailing vehicle (i.e., first vehicle) based on the crowdsourced data to increase safety for passengers in the trailing vehicle is disclosed. Vehicles sensors and roadway sensors may collect roadway data in relation to obstacles and objects (i.e., hazardous conditions) on a roadway. The roadway data may be transmitted to a cloud based server. Moreover, vehicles passing the hazardous condition may transmit data related to any action that it took in response to the existence of the hazardous condition and also its capabilities to the cloud based server. The trailing vehicle may transit data related to its capability to the cloud based server. Based on the relative capability data between the leading vehicle and the trailing vehicle, the cloud based server may transit computer instruction data to a computer of the trailing or first vehicle. The computer instruction data includes recommended courses of action to increase the safety for passengers of the trailing or first vehicle as the trailing or first vehicle traverses the hazardous roadway condition.

To implement the method described above, a device attachable to an onboard computer of a vehicle is described herein. The device may have a connector, a processor and a non-transitory, computer readable storage medium. The connector may be sized and configured to be in electrical communication with the onboard computer of the vehicle. The processor may be in electrical communication with the connector. The non-transitory, computer readable storage medium may contain a computer program. When the computer program is executed by the processor, the processor performs the following steps which increases safety to a passenger of the vehicle. The steps include providing electronic data regarding a capability of a primary vehicle (e.g., based on a VIN of the vehicle); receiving electronic data regarding a roadway condition sensed by a leading vehicle which is on a route where the primary vehicle will be passing through; deriving one or more implementable actions based on the electronic roadway condition data and electronic vehicle capability data to increase safety for passengers of the primary vehicle; and transmitting the one or more commands to onboard computer of the primary vehicle.

The implementable commands to the vehicle include and are not limited to displaying a warning signal on a computer screen of the vehicle, activating brakes of the vehicle to slow down the vehicle, modifying a suspension of the vehicle, turning on a left or right turn signal of the vehicle, activating a horn of the vehicle.

In the providing step, this step may include the steps of accessing the computer system of the primary vehicle; retrieving a vehicle identification number of the primary vehicle; transmitting the vehicle identification number of the primary vehicle to a cloud based server to look up a configuration of the primary vehicle; and receiving the electronic capability data of the primary vehicle from the cloud based server.

The step of receiving electronic data regarding roadway conditions sensed by the leading vehicle that has already been where the primary vehicle will pass through may include the steps of receiving the electronic roadway condition data via a wireless direct communication with a receiver on the primary vehicle from a transmitter from the leading vehicle. Alternatively, the electronic roadway condition data may be communicated to the following vehicle wirelessly (e.g., cellular network) from a cloud based server.

In the steps discussed above, the electronic capability data of the primary vehicle may be related to at least one of a suspension of the primary vehicle, a horsepower of the primary vehicle, and a braking capability of the primary vehicle.

In the steps discussed above, the electronic roadway condition data may relate to a location of the condition and at least one of the following: an object on a roadway, a slippery condition on the roadway, a dip on the roadway, and a pot hole on the roadway.

The deriving step may include a step of ignoring (i.e., not sending any recommendation to the driver of the primary vehicle) an object on the roadway if the suspension of the vehicle can accommodate the object on the roadway. If the upcoming hazard cannot be ignored, then the deriving step may, for example, recommend a lane change to avoid an object on the roadway if the suspension of the vehicle cannot accommodate the object on the roadway.

The transmitting step may entail sending an electronic signal to the computer system of the primary vehicle.

In the above description, a device that is attachable to the onboard computer of a primary vehicle was discussed. The device communicated with the onboard computer in order to send commands to the onboard computer and communicate with the driver of the primary vehicle. For example, as discussed above, the device would send a signal to the onboard computer of the primary vehicle to display a message on the primary vehicle’s dashboard computer screen that says “Upcoming Obstacles, Slow Down” or some other relevant message related to the upcoming hazardous situation. However, it is also contemplated that a software program may be installed on the onboard computer so that the onboard computer is performing the steps of the software program. It is also contemplated that the processing of the software program may be performed on a cloud based server instead of locally on the device or the onboard computer of the primary vehicle.

The data being processed per the software program may be transmitted to the processor differently based on where the processing of the data is occurring. For example, if the processing occurs on the device attached to the primary vehicle, then the leading vehicle may transmit electronic roadway condition data to the device via a Vehicle to Anything (V2X) communication protocol such as to a device mounted to a light pole then to the device attached to the vehicle. If the processing occurs on the onboard computer of the primary vehicle, then the leading vehicle may transmit electronic roadway condition data to the primary vehicle via a Vehicle to Vehicle (V2V) communication protocol. If the processing occurs on a cloud based server, the leading vehicle and the primary vehicle may transmit the electronic roadway condition data wirelessly to the cloud based server for example over a cellular network.

In another aspect, a method of increasing safety to a passenger of a primary vehicle is disclosed. The method may comprise the steps of providing electronic data regarding a capability of a primary vehicle; receiving electronic data regarding a roadway condition sensed by a leading vehicle and on a route of the that has already been where the primary vehicle will be passing through; deriving one or more implementable actions based on the electronic roadway condition data and electronic vehicle capability data to derive one or more commands implementable on the vehicle to increase safety for passengers of the primary vehicle; transmitting the one or more commands to a computer system of the primary vehicle.

In another aspect, a non-transitory, computer readable storage medium containing a computer program, which when executed by a processor, causes the processor to carry out actions to increase safety to a passenger of a primary vehicle is disclosed. The actions may comprise providing electronic data regarding a capability of a primary vehicle; receiving electronic data regarding a roadway condition sensed by a leading vehicle and on a route of the that has already been where the primary vehicle will be passing through; deriving one or more implementable actions based on the electronic roadway condition data and electronic vehicle capability data to derive one or more commands implementable on the vehicle to increase safety for passengers of the primary vehicle; and transmitting the one or more commands to a computer system of the primary vehicle.

### BRIEF DESCRIPTION OF THE DRAWINGS

FIG. 1A is a diagram of a vehicle with a device installed for sensing upcoming object and implementing safety actions on the vehicle;

FIG. 1B is a diagram of the vehicle with the device installed for sensing upcoming water puddle and implementing safety actions on the vehicle;

FIG. 1C is a diagram of the vehicle with the device installed for sensing upcoming pedestrian and implementing safety actions on the vehicle;

FIG. 2A is a diagram of a leading vehicle which senses an upcoming object and transmits such data to a trailing vehicle to implement safety action on the trailing vehicle;

FIG. 2B is a diagram of the leading vehicle which senses an upcoming water puddle and transmits such data to the trailing vehicle to implement safety action on the trailing vehicle;

FIG. 2C is a diagram of a leading vehicle which senses an upcoming pedestrian and transmits such data to the trailing vehicle to implement safety action on the trailing vehicle;

FIG. 3 is a schematic of the device installed on the trailing vehicle and how data is transmitted to the processor 18 of the device and transmitted to the ECU of the vehicle and actionable safety precautions are implemented on the trailing vehicle; and

FIG. 4 is a top view of a plurality of vehicles utilizing the system, method and device disclosed herein.

### DETAILED DESCRIPTION

Referring now to the drawings, roadway conditions 16a, b, c may be sensed by vehicle sensors 30 and roadway sensors 31 mounted on the roadway. Some of these roadway conditions 16a, b, c may be considered to be a hazardous roadway condition. This data may be transmitted to a computer (e.g., cloud based server 24). As vehicles 36 pass by the hazardous roadway conditions, these vehicles 36 may take corrective actions (e.g., slow down, change lanes). Data related to the capabilities of these vehicles 36 and the corrective actions that these vehicles 36 took may be transmitted to the computer 24. Vehicles 12 that have yet to come upon the hazardous roadway conditions may transmit its capabilities to the computer 24. The computer 24 may process the crowdsourced transmitted data and provide a recommended course of action to the trailing vehicle 12 to increase safety for passengers of the trailing vehicle 12. By way of example and not limitation, the recommended course of action may be derived from comparing actions taken by similar or less capable leading vehicles 36 to the trailing vehicle 12 that have successfully traversed the hazardous roadway condition and recommending those successful courses of action to the trailing vehicle.

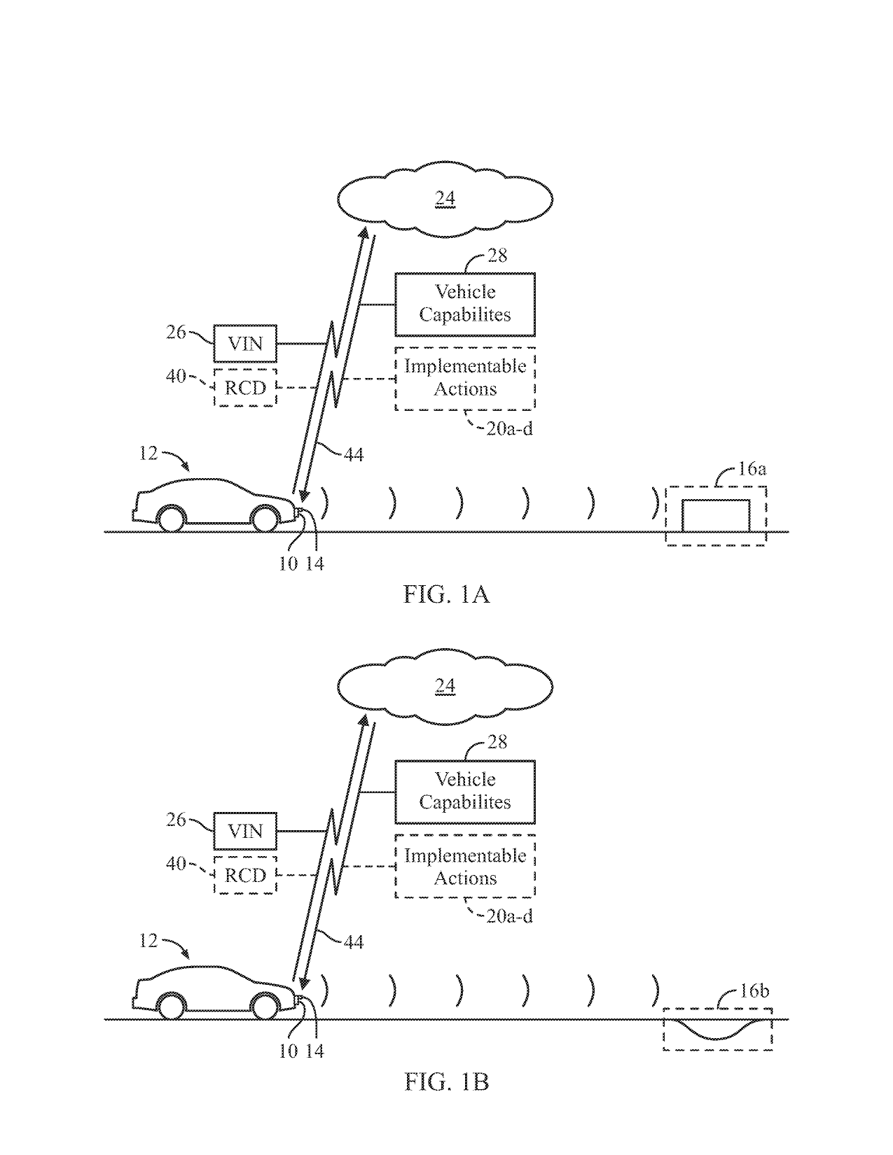

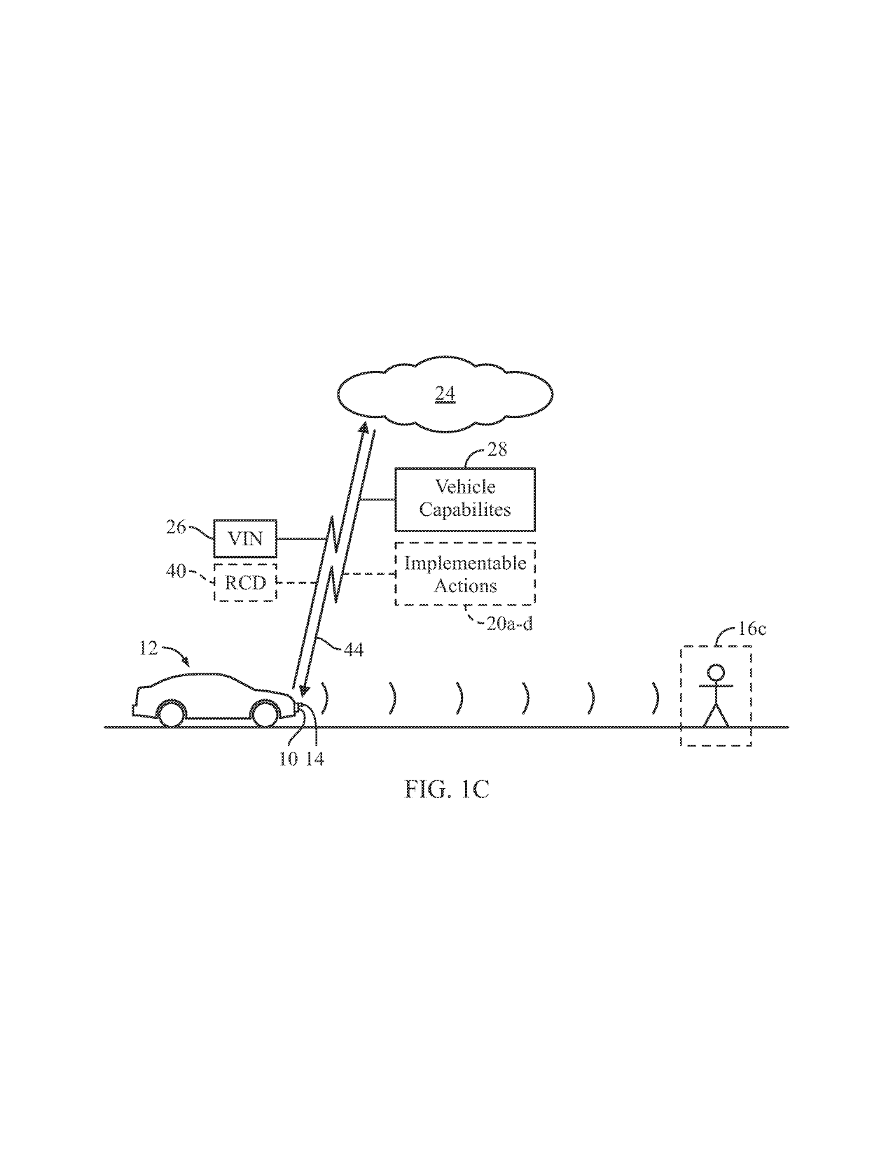

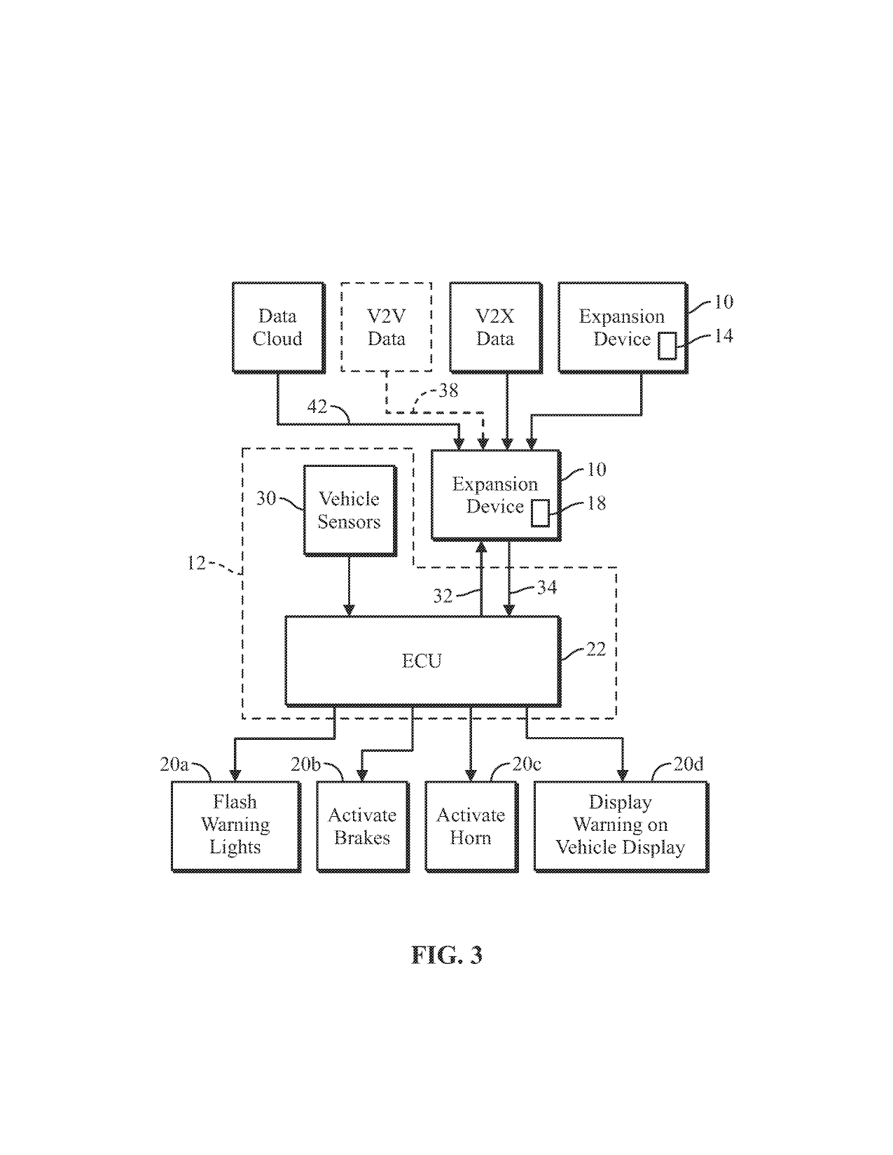

To enable vehicles 12 to implement the method described herein, a device 10 (see FIGS. 1A-C) can be attached to an onboard computer 22 (see FIG. 3) of a vehicle 12. The device enables electronic communication with the computer 24. In some embodiments, the computer is not processed in the cloud but is processed locally on the vehicle. To that end, the device 10 attached to the onboard computer 22 can process electronic data regarding the capability of the vehicle 12 and upcoming roadway conditions 16a-c (see FIGS. 1A-C) sensed by a leading vehicle 36 on a route that the vehicle 12 will be traveling to provide recommendations to the driver of the vehicle 12.

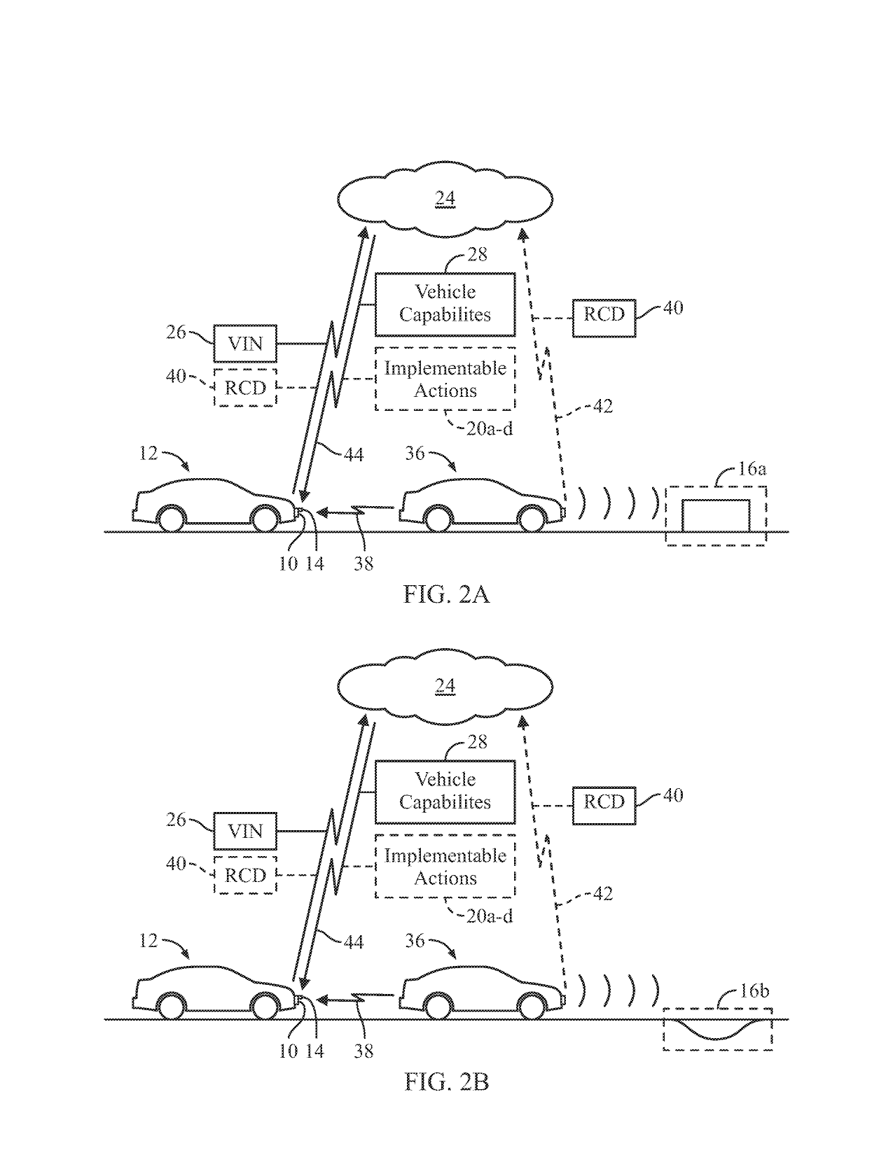

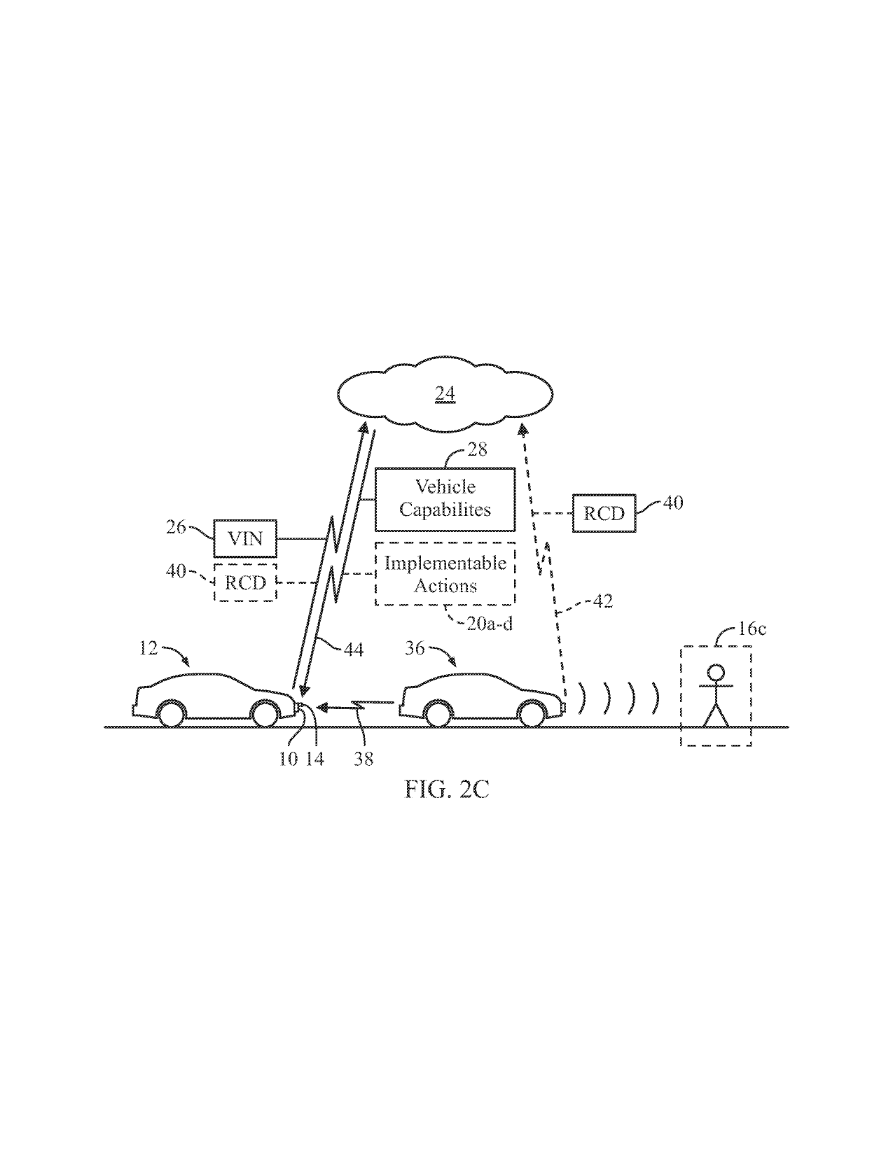

For example, the device 10 may have a processor 18 (see FIG. 3) that performs the following steps to increase safety to a passenger of the vehicle 12. Electronic data 28 (see FIGS. 1A-2C) regarding the capability of the primary vehicle is retrieved by the device by using the vehicle identification number (VIN) of the primary vehicle. Electronic data regarding an upcoming roadway condition 16a-c sensed by a leading vehicle 36 on a route that has already been traversed by the leading vehicle and will be traveled by the vehicle 12 is received by the device 10. The processor 18 of the device 10 processes this information (e.g., vehicle capabilities 28, upcoming road condition data 40) and derives one or more implementable actions 20a-d to increase safety for passengers of the vehicle 12. The implementable actions 20a-d are conveyed to an onboard computer 22 (e.g., ECU, See FIG. 3) of the vehicle 12 and expressed by way of displaying a message on the computer screen of the vehicle 12, activating the brakes of the vehicle 12 to slow down the vehicle 12, or steering the vehicle 12 into a different lane. The implementable actions 20a-d may be different for different vehicles. By way of example and not limitation, the device 10 may send a signal to cloud based server 24. The signal may contain the vehicle identification number data 26 of the vehicle. In response, the cloud based server 24 can send data 28 related to the capabilities of the vehicle 12. When the VIN identifies the vehicle 12 as a raised 4 wheel driver truck with a superior suspension, the implementable action 20a-d may be to display a warning on the vehicle’s computer screen to inform the driver that a small object 16a is on the road. It would be safer for this type of off road vehicle to run over such an object in its path instead of change lanes to avoid the object 16a. However, if the VIN identifies the vehicle 12 as a Honda Civic, the implementable action 20a-d may be to instruct the driver change lanes to avoid the object 16a since the object 16a might damage (i.e., blow out its tires) the Honda Civic and cause a crash.

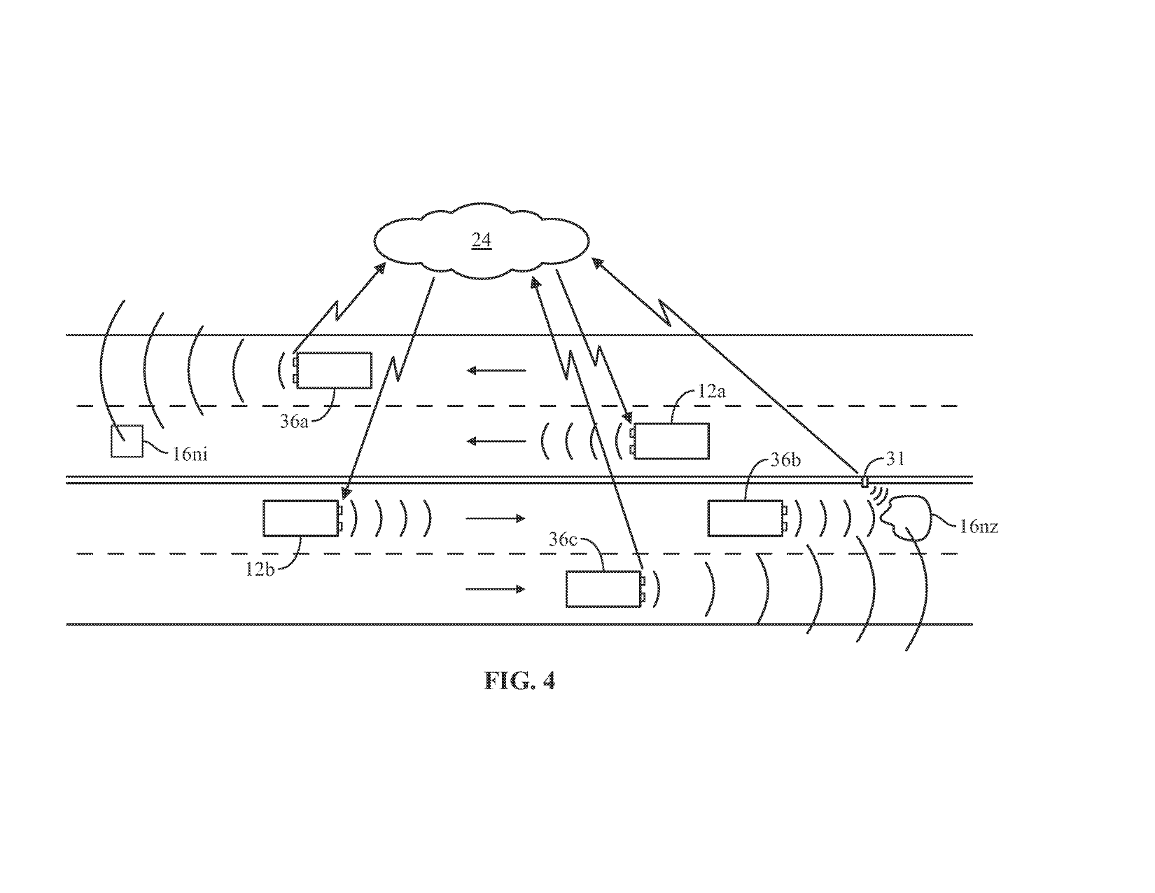

The data 40 regarding upcoming roadway conditions may be sensed by the device (see FIGS. 1A-C) or a sensor from a leading vehicle(s) (see FIGS. 2A-C). In this way, roadway conditions may be crowdsourced. If the data 40 is sensed from the leading vehicle as shown in FIGS. 2A-C, then the data may be communicated to the device 10 by way of a vehicle to anything (V2X) communication signal 38 (see FIGS. 2A-C) or through a V2X compatible device attached to a light pole 46 (see FIG. 4) then to the device 10 attached to the vehicle 12. Alternatively or additionally, the data may be communicated to the device from the leading vehicle to the cloud based server 24 via signal 42 (see FIGS. 2A-C) and then to the device 10 via signal 44 through a wireless network, as shown in FIGS. 2A-C.

The processing of the data 40, 28 may occur on the device 10 but it is also contemplated that the processing of the data 40, 28 may occur on the onboard computer 22 (e.g., ECU) of the vehicle 12 or on the cloud based server 24. In these cases, a vehicle to vehicle communication signal 38 and/or wireless network may be used to transmit the data 40, 28 to the processor 18, 22 which will process the data 40, 28. If the data 40, 28 is processed on the processor 18 of the device 10, the processor 18 will transmit the one or more recommended courses of action 20a-d (i.e., implementable actions) to the onboard computer 22 of the vehicle 12. If the data 40, 28 is processed on the processor or ECU 22 of the vehicle, the processor or ECU 22 will implement the recommended courses of action 20a-d.

More particularly, one area where vehicle safety can be improved is in the ability of a vehicle 12 to respond to changing roadway conditions. For example, if a vehicle 12 senses a slippery road surface, it may be able to adjust its speed and braking accordingly to avoid a potential accident. However, not enough time may exist for the sensors to sense then implement precautions to increase safety. For example, the sensors might sense a water puddle which increases hydroplaning of the vehicle, an oversized object that the vehicle might run over, a pedestrian which the vehicle would have to avoid. In order to give the sensors and processor on the device 10 installed on the vehicle 12 enough time to process the data and implement corrective actions, the upcoming roadway condition data 40 may be sensed by a sensor mounted to the leading vehicle, as shown in FIGS. 2A-C. By crowdsourcing data, the data communication infrastructure need not be as robust because the leading vehicle transmits data to the trailing vehicle. By the time, the trailing vehicle reaches the roadway condition, processes have sufficient time to process the data and recommend courses of action to the trailing vehicle. For example, a vehicle may follow behind a leading vehicle by 2 to 3 seconds. When the sensors of the leading vehicle 12 sense a relevant upcoming roadway condition 40, the computer of the leading vehicle can transmit the upcoming roadway condition data to the computer of the primary vehicle by way of V2V communication protocol directly to the vehicle behind it or by way of V2X communication protocol to the device 10 installed on the vehicle behind it. The time that it takes for the data 40 to reach the processor 18 where the data is processed or the implementable actions to reach the primary vehicle’s on board computer 22 is less than the time it takes the vehicle 12 traveling at a particular speed to reach the upcoming roadway condition sensed by the leading vehicle 36. In this manner, it increases a performance of the processor 18, 22 where the data is being processed.

Referring now to FIGS. 1A-1C, the device 10 may be mounted to a vehicle (i.e., primary vehicle) 12. In particular, the device 10 may be connected to the onboard computer of the vehicle 12 so as to provide a data communication channel or link 32, 34 (see FIG. 3) between the device 10 and the onboard computer of the vehicle 12. The data communication link 34 enables data transfer from the device 10 to the onboard computer of the vehicle 12.

The device 10 may have a sensor 14 which senses an upcoming road condition 16 such as an object 16a, water puddle 16b or person 16c. When a vehicle 12 does not have a sensor for sensing upcoming road conditions, the device 10 may provide for such additional function to the vehicle. The device 10 may have one or more sensors 14 for sensing upcoming road conditions. By way of example and not limitation, one or more of the following types of sensors may be a part of the device 10 such as a LIDAR sensor, an ultrasonic sensor, a radar sensor and a camera. These sensor 14 may detect a size (e.g., length, width, and/or height) of the object 16a, b, c. The sensors 14 may also calculate a distance from the vehicle 12. The device may also have a GPS receiver to determine its location. The device 10 may have a processor 18 (see FIG. 4) which processes the data from the sensor and the GPS receiver. The processor 18 may then derive one or more implementable actions that the ECU or onboard computer 22 of the vehicle can implement.

The ultrasonic sensor uses high frequency sound waves to detect objects in its path. These sensors emit sound waves that bounce off objects and return to the sensor. By measuring the time it takes for the sound waves to bounce back, the sensor can calculate the distance to the object. The ultrasonic sensor may also measure a size (e.g., length, width, and height) of the object 16a, b, c and transmit the data to the processor for processing to provide implementable actions. The radar sensor uses radio waves to detect objects. These sensors emit radio waves that bounce off objects and return to the sensor. By measuring the frequency shift of the returning waves, the sensor can calculate the distance of the object from the device 10. The camera uses one or more cameras to detect the size and distance of objects. These sensors use image recognition software to analyze the images captured by the camera(s) and identify objects both in terms of its size (length, width, height) and distance from the device 10. One or more of different or same types of sensors 14 may be installed as a part of the device 10 to help the device gather data related to upcoming roadway conditions which is processed by the processor 18.

The data associated with the upcoming road conditions may be obtained from sensors built into the device 10. Additionally or alternatively, the data associated with the upcoming road conditions may be obtained from sensors 30 on the vehicle 12 or roadway sensors 31 (see FIG. 4). These sensors 30, 31 may be the same sensor 14a, b, c or different sensors that are discussed herein. When the vehicle 12 senses the upcoming road conditions using its built in sensors 30, the data associated with the upcoming road conditions sensed by the vehicle’s built in sensors 30 may be communicated (see communication line 32 in FIG. 3) to the device 10 so that it can be processed by the processor 18 of the device 10.

Referring now to FIGS. 2A, B, C, the data associated with the upcoming road conditions may be obtained by sensors from vehicles 36 (i.e., lead vehicles) in front of the vehicle 12 (i.e., following vehicle or trailing vehicles). The method described herein contemplates crowdsourcing sensing and gathering of the data from the lead vehicles 36 and roadway sensors 31. The lead vehicle 36 refers to the vehicle that is in front of the following or trailing vehicle 12. On the other hand, a following or trailing vehicle 36 is a vehicle that is following or trailing behind the lead vehicle. This vehicle is typically following the same route and direction as the lead vehicle 36.

The lead vehicle 36 will sense roadway conditions that it will encounter and will transmit the data associated with its sensed upcoming roadway conditions to the trailing or following vehicle. The upcoming roadway condition data may be transmitted to the processor 18 of the device 10 installed on the trailing vehicle 12 by way of a vehicle to vehicle communication transmission 38 (see FIGS. 2A, B, C and 3). Additionally or alternatively, the upcoming roadway condition data 40 from the lead vehicle 36 may be communicated or transmitted to the processor 18 of the device 18 installed on the trailing vehicle 12 over wireless network. By way of example and not limitation, the roadway condition data 40 of the lead vehicle 36 may be uploaded to the cloud based server 24 through wireless communication 42. The roadway condition data 40 from the lead vehicle 36 is then downloaded to the device 12 through wireless communication 44. The time that it takes of the roadway condition data to be sensed, uploaded to the server 24 and downloaded to the device 12 By doing so, the trailing vehicle 12 may be less than the time it takes for the trailing vehicle 12 to reach the location of the sensed harzardous condition. The device 12 transmits implementable actions 20a, b, c, d to the ECU 22. The ECU (electronic control unit) of the vehicle causes implementation of the implementable actions 20a-d.

The lead vehicle in addition to transmitting roadway condition data to the server 24, the lead vehicle would have taken an action as it traversed past the roadway condition. For example, the lead vehicle 36 may have stayed the course and traversed over the roadway condition. The lead vehicle 36 may have slowed down or changed lanes to traverse past the roadway condition. These data representing these actions of the lead vehicle may be transmitted to the server 24. Moreover, the capabilities of the lead vehicles may be transmitted to the server 24. For example, the lead vehicle 36 may transmit its vehicle identification number to the server 24. The server 24 may look up the build configuration of the lead vehicle 36. For lead vehicles 36 that have successfully traversed past the hazardous condition and have similar capabilities of the trailing vehicle, the server may transmit computer instructions to the computer of the trailing vehicle representing those actions taken by the lead vehicles.

Referring still to FIG. 1, the device 10 as discussed above is in data communication with the onboard computer 22. The device 10 may retrieve a vehicle identification number (VIN) number of the vehicle 12 to which the device 10 is connected to. The device 10 may transmit the VIN number 26 wirelessly to a cloud based server 24 which contains data related to the VIN number. By way of example and not limitation, the cloud based server 24 may have information related to the build or capabilities 28 of the vehicle 12 including but not limited to ground clearance data, four wheel drive or two wheel driver, front wheel driver or rear wheel drive, make and model of the vehicle, and the like to the device 10.

Based on the characteristics of the object sensed by the sensors of the following vehicle 12, capabilities of the lead vehicle 36 and/or the device 12 in conjunction with the type of trailing vehicle identified by the VIN, the processor 18 of the device derives one or more implementable actions 20a-d. By way of example and not limitation, if the trailing vehicle 12 is a 4wd car with great suspension and an object is detected on the roadway, the processor might recommend to send a signal to the ECU 22 to display a message on the vehicle’s computer screen to slow down but not change lanes because changing lanes may be more dangerous to the passenger of the vehicle and others on the road. On the other hand, if the vehicle is a small 2 door 2 wheel drive car and an object is detected on the roadway, the processor might send a signal to the ECU 22 of the vehicle 12 to activate the brakes 20b of the vehicle 12 to slow the vehicle down and/or display a message on the vehicle’s computer screen to change lanes. Additionally, the signal sent to the ECU may be actively steer the vehicle away from the object on the road or activate a turn signal of the vehicle to instruct the driver to change lanes.

The various aspects discussed herein provide a device and method for improving vehicle safety by providing recommended actions to a driver based on roadway conditions and the type of vehicles 12, 36 being operated. By taking into consideration the unique characteristics of each vehicle 12, 36 and the specific conditions on the roadway, the system can help drivers make informed decisions to avoid accidents and stay safe on the road.

The implementable actions 20a-d are only examples and are not meant to limit the types of actions that can be recommended. Other types of implementable actions are also contemplated. The implementable actions are signals from the processor 18 of the device 12 to the ECU 22 of the vehicle which controls the ECU 22 so that the ECU 22 causes the vehicle’s system to flash warning lights 20a, activate the brakes 20b of the vehicle 12, activate a horn 20c of the vehicle 12, display a message on the vehicle’s computer screen 20d, and other implementable actions 20n.

Referring now to FIG. 4, lead vehicles 36a, b, c and trailing vehicles 12a, b are shown. Additionally, objects 16n1 and 16n2 are shown. These objections may be a ladder, box, water puddle, person, pot hole, etc. Anything on the road that creates a hazardous situation. As shown, lead vehicle 36a are in front of the trailing vehicles 12a, b. The sensors of the lead vehicles 36a, b may sense objects or harzards in front of them. The sensed object may be communicated to the cloud based server 24 which transmits the data to the processors of the devices installed on others trailing vehicles travelling on the same path. For example, the sensed data from lead vehicle 36a would be transmitted to the processors of the device installed on vehicle 12a but not vehicle 12b. The sensed data from lead vehicles 36b, c would be transmitted to the processors of the device installed on vehicle 12b but not vehicle 12a. Moreover, the vehicles 12a, b may themselves have sensors which detect objects in front of it and such sensed data is transmitted to the processors 18 of the devices 10 installed on their respective vehicles 12a, b. In general, previously, the processors 18 of the devices 10 installed on the trailing vehicles 12a, b transmitted its VIN to the cloud based server 24. In response, the cloud based server 24 transmitted the build of the vehicle 12a, b back to the processor. Based on the data gathered from all sources regarding objects on the road and the build of the vehicle, the processor 18 of the device transmits implementable actions to the ECU 22 of the vehicle 12a, b. The ECU implements the implementable actions. These implementable actions may be different for different vehicle builds. The implementable action of a sports car build may be to swerve into a different lane. The implementable action of a Honda Civic build may be to slow down and stop before hitting the object.

As discussed herein, the processor 18 on the device 10 installed on the trailing vehicle was described as receiving the roadway condition data and the vehicle capabilities then processing the data to provide implementable actions to the ECU. However, it is also contemplated that the data regarding the roadway conditions and the capabilities of the vehicle 12 may be transmitted to the cloud based server 24. The cloud based server then transmits implementable actions to the ECU of the vehicle 12a, b. Instead of the processor 18 on the device or the cloud based server deriving or processing the data, it is also contemplated that the software program may be installed or embedded on the onboard computer system of the vehicle 12a, b.

As discussed herein, the device transmits the VIN of the vehicle 12 on which it is installed to a cloud based server to download data regarding the capabilities or build of the vehicle 12. However, it is also contemplated that the device can be put into communication with a computer which accesses the cloud based server 24 before the device 10 is installed on the vehicle 12. The capabilities or build of the vehicle 12 is downloaded onto the device. The device 10 is then installed onto the vehicle by securing mounting the device to the vehicle and connecting its processor to the ECU 22 of the vehicle 12.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of increasing safety for a passenger of a first vehicle, the method comprising the steps of:
receiving computer instructions representing one or more implementable actions wherein the implementable actions are based on a comparison between a first electronic data of a first vehicle and a second electronic data of a leading vehicle;
activating at least one of a computer screen, brake system, turn signals, and suspension system of the first vehicle based on the received computer instructions.

2. A method of increasing safety for a passenger of a first vehicle, the method comprising the steps of:
providing a first electronic data including data relating to a capability of the first vehicle;
receiving a second electronic data including data relating to a remote roadway condition, a capability of a leading vehicle traversing the remote roadway condition, a corrective action taken by the leading vehicle to mitigate danger arising from the remote roadway condition, and an assessment of the corrective action taken by the leading vehicle;
comparing the second electronic data of the leading vehicle with the first electronic data of the first vehicle to derive one or more implementable actions that increase safety for passengers of the first vehicle;
transmitting the one or more implementable actions to a computer of the first vehicle.

3. The method of claim 2 wherein the transmitting step includes a step of transmitting instructions to the computer of the first vehicle to display a warning signal on a computer screen of the first vehicle.

4. The method of claim 2 wherein the transmitting step includes a step of transmitting instructions to the computer of the first vehicle to activate a brake system of the first vehicle to slow down the first vehicle.

5. The method of claim 2 wherein the transmitting step includes a step of transmitting instructions to the computer of the first vehicle to modify a suspension of the first vehicle, turning on a left or right turn signal of the first vehicle, activating a horn of the first vehicle, or combinations thereof.

6. The method of claim 2 wherein the providing step comprises step of:
accessing a computer of the first vehicle;
retrieving a vehicle identification number of the first vehicle from the computer;
transmitting the vehicle identification number of the first vehicle to a cloud based server to look up the capability of the first vehicle;
receiving the first electronic data from the cloud based server.

7. The method of claim 2 wherein the step of receiving the second electronic data comprises receiving the second electronic data via a wireless direct communication with a receiver on the first vehicle from a transmitter on the leading vehicle.

8. The method of claim 2 wherein the step of receiving the second electronic data comprises receiving electronic roadway condition data over a wireless network from a cloud based server.

9. The method of claim 2 wherein the first electronic data is at least one of a suspension of the first vehicle, a horsepower of the first vehicle, a ground clearance of the first vehicle, and a braking capability of the first vehicle.

10. The method of claim 2 wherein the second electronic data comprises a GPS location of the roadway condition and a characterization of the roadway condition being at least one of an object on a roadway, a slippery condition on the roadway, a dip on the roadway, and a pot hole on the roadway.

11. The method of claim 2 wherein the comparing step includes comparing a ground clearance of the first vehicle and a ground clearance of the second vehicle to determine if the first vehicle can accommodate the roadway condition without a lane change.

12. The method of claim 11 wherein the implementable action is display a lane change recommendation if the ground clearance of the first vehicle is equal to or less than the ground clearance of the leading vehicle and the lead vehicle changed lanes to traverse the remote roadway condition.

13. The method of claim 2 wherein the transmitting step comprises sending an electronic signal to the computer system of the first vehicle.

14. A non-transitory, computer readable storage medium containing a computer program, which when executed by a processor, causes the processor to carry out actions to increase safety to a passenger of a first vehicle, the actions comprising:
providing a first electronic data regarding a capability of the first vehicle;
receiving a second electronic data regarding a remote roadway condition, capability of a leading vehicle traversing the remote roadway condition, a corrective action taken by the leading vehicle to mitigate danger arising from the remote roadway condition, and an assessment of the corrective action;
comparing the second electronic data and first electronic data to derive one or more implementable actions which increase safety for passengers of the first vehicle;
transmitting the one or more implementable actions to a computer of the first vehicle.

15. A device attachable to an onboard computer of a first vehicle that increases safety of the first vehicle, the device comprising:
a connector sized and configured to be in electrical communication with the onboard computer of the first vehicle;
a processor in electrical communication with the connector;
a non-transitory, computer readable storage medium containing a computer program, which when executed by the processor, causes the processor to carry out actions to increase safety to a passenger of the first vehicle, the actions comprising:
providing a first electronic data regarding a capability of the first vehicle;
receiving a second electronic data regarding a remote roadway condition, capability of a leading vehicle traversing the remote roadway condition, a corrective action taken by the leading vehicle to mitigate danger arising from the remote roadway condition, and an assessment of the corrective action;
comparing the second electronic data and first electronic data to derive one or more implementable actions which increase safety for passengers of the first vehicle;
transmitting the one or more implementable actions to a computer of the first vehicle.
